(19) United States
(12) Patent Application Publication
(10) Pub. No.: US 2014/0054904 A1
(43) Pub. Date: Feb. 27, 2014

(54) MAGNETO-MECHANICAL-LATCHING-ASSEMBLY

(71) Applicants: Stuart John Andrews, Deakin ACT (AU); Mark Cumming, New South Wales (AU)

(72) Inventors: Stuart John Andrews, Deakin ACT (AU); Mark Cumming, New South Wales (AU)

(21) Appl. No.: 13/595,779

(22) Filed: Aug. 27, 2012

(51) Int. Cl. E05C 19/16; E05C 1/08

(52) U.S. Cl. 292/144; 292/251.5

(57) ABSTRACT

A combination of a door, a door-jamb and a magneto-mechanical-latching-assembly is provided. The door is mounted to close an opening adjacent to the door-jamb. The latching-assembly operates to secure the door in a closed position. The latching-assembly includes a latch-component and an actuator-component. The latch-component is associated with one of the door and door-jamb. The latch-component includes a latch that includes a latch-magnet having a latch-magnet-polar-axis. The latch is mounted relative to the latch-component to reciprocate along a substantially horizontal and linear latching-path between an extended-latching-position and a retracted-non-latching-position. The actuator-component is associated with the other of the door and door-jamb. The actuator-component includes an actuator that includes an actuator-magnet having an actuator-magnet-polar-axis. The actuator-magnet is mounted relative to the actuator-component to reciprocate along a substantially vertical actuator-path between a latch-magnet-attracting-position and a latch-magnet-repelling-position.

### FIELD OF THE INVENTION

This invention relates to a magneto-mechanical-latching-assembly for automatically-latching doors and gates in a closed position.

### BACKGROUND OF THE INVENTION

Automatically-latching doors are often spring-biased towards the closed position. Upon reaching the closed position, a latch automatically secures the door in the closed position.

Many latching systems are relatively bulky and/or they involve complex designs which have multiple moving parts, such as springs and other components, which are prone to fatigue and failure. Further, many latching systems do not reliably latch the door, particularly where a latch needs to be urged against a spring-bias during the latching process. Additionally, in the majority of cases, when the door is open, the latch is exposed such that it can be a potential hazard to passers-by. In this regard, it is noteworthy that latches are often at head height for children.

### BRIEF SUMMARY OF THE INVENTION

Embodiments of the present invention provide a new and improved magneto-mechanical latching assembly.

In a particular embodiment, a combination of a door, a door-jamb and a magneto-mechanical-latching-assembly is provided. The door is mounted to close an opening adjacent to the door-jamb. The magneto-mechanical-latching-assembly operates to secure the door in a closed position. The magneto-mechanical-latching-assembly includes a latch-component and an actuator-component. The latch-component is associated with one of the door and door-jamb. The latch-component includes a latch. The latch includes a latch-magnet having a latch-magnet-polar-axis. The latch is mounted relative to the latch-component to reciprocate along a substantially horizontal and linear latching-path between an extended-latching-position and a retracted-non-latching-position. The actuator-component is associated with the other of the door and door-jamb. The actuator-component includes an actuator. The actuator includes an actuator-magnet having an actuator-magnet-polar-axis. The actuator-magnet is mounted relative to the actuator-component to reciprocate along a substantially vertical actuator-path between a latch-magnet-attracting-position and a latch-magnet-repelling-position.

In a more particular combination, when the latch is in the retracted-non-latching-position, the latch is substantially flush with the door or door-jamb.

In a more particular embodiment, the latch-magnet-polar-axis is substantially horizontal and substantially parallel to the latching-path, and the actuator-magnet-polar-axis is substantially vertical and substantially parallel to the actuator-path.

In a more particular embodiment, the latch-component is associated with the door-jamb and the actuator-component is associated with the door.

In a more particular embodiment, the substantially horizontal and linear latching-path is substantially parallel to the plane of the opening.

In a more particular embodiment, the substantially horizontal and linear latching path lies in the plane of the opening such that the latch projects into the plane of the opening when the latch is in the extended-latching-position.

In a more particular embodiment, the actuator-path is arcuate.

In a more particular embodiment, the actuator comprises a handle, and the handle is mounted for limited rotational travel relative to the actuator.

In a more particular embodiment, the latch-component is associated with the door and the actuator-component is associated with the door-jamb.

In a more particular embodiment, the actuator-path is linear.

In a more particular embodiment, the substantially horizontal and linear latching-path is substantially parallel to the plane of the door.

In a more particular embodiment, the actuator-magnet is mounted for limited vertical travel relative to the actuator in order to accommodate vertical misalignment of the door relative to the door-jamb.

In a more particular embodiment, biasing means bias the actuator-magnet towards one end of said limited vertical travel.

In a more particular embodiment, the latch-magnet has a vertical dimension (A) in a direction substantially transverse to the latching-path, and the actuator-magnet has a vertical dimension (B) in a direction substantially parallel to the actuator-path, and the actuator-magnet travels a vertical distance of approximately A+B along the actuator-path between the latch-magnet-attracting-position and the latch-magnet-repelling-position.

In a more particular embodiment, the latch-magnet is cylindrical with the axis of the cylinder substantially aligned with the latch-magnet-pole-axis and latching-path, and wherein the actuator-magnet is cylindrical with the axis of the cylinder substantially aligned with the actuator-magnet-pole-axis and actuator-path, and the cylindrical-latch-magnet and cylindrical-actuator-magnet are substantially in opposed edge-to-edge juxtapositions when in each of the latch-magnet-attracting-position and the latch-magnet-repelling-position.

In a more particular embodiment, when the actuator-magnet is in the latch-magnet-attracting-position, the actuator-magnet is substantially located vertically to one side of the latching-magnet and, when the actuator-magnet is in the latch-magnet-repelling-position, the actuator-magnet is substantially located vertically to the other side of the latching-magnet.

In another embodiment, a magneto-mechanical-latching-assembly suitable for use in combination with a door and a door-jamb as defined above is provided.

In another embodiment, a magneto-mechanical-latching-assembly including a latch-component and an actuator-component is provided. The latch-component is adapted to be associated with one of a door and door-jamb. The latch-component includes a latch. The latch includes a latch-magnet having a latch-magnet-polar-axis. The latch is mounted relative to the latch-component to reciprocate along a linear latching-path between an extended-latching-position and a refracted-non-latching-position. The actuator-component is adapted to be associated with the other of the door and door-jamb. The actuator-component includes an actuator. The actuator includes an actuator-magnet having an actuator-magnet-polar-axis. The actuator-magnet is mounted relative to the actuator-component to reciprocate along an actuator-path between a latch-magnet-attracting-position and a latch-magnet-repelling-position.

In a more particular embodiment, when the latch is in the retracted-non-latching-position, the latch is retracted to a substantially flush position.

In a more particular embodiment, the actuator comprises a handle and the handle is mounted for limited rotational travel relative to the actuator.

In a more particular embodiment, the actuator-magnet is mounted for limited vertical travel relative to the actuator.

In a more particular embodiment, biasing means bias the actuator-magnet towards one end of said limited vertical travel.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1 through 9 show an embodiment (particularly suitable for use with residential doors and the like) in which the actuator-magnet moves in an arcuate path, and in which:

FIG. 1 is a schematic showing the actuator-magnet in each of the latch-magnet-attracting-position and the latch-magnet-repelling-position;

FIG. 2 is a vertical cross-section showing the actuator-magnet in the latch-magnet-attracting-position;

FIG. 3 is a vertical cross-section showing the actuator-magnet in the latch-magnet-repelling-position;

FIG. 4 is a perspective view of the vertical cross-section of FIG. 2;

FIG. 5 is a perspective view of the vertical cross-section of FIG. 3;

FIG. 6 is a partial cutaway perspective view showing the actuator-magnet in the latch-magnet-attracting-position;

FIG. 7 is a partial cutaway perspective view similar to FIG. 6 and showing the actuator-component in situ within a door (the door-jamb is not shown in FIG. 7);

FIG. 8 is a vertical cross-sectional view of FIG. 7 (the door-jamb is shown in FIG. 8); and

FIG. 9 is a cutaway perspective view of a door prior to installation of the actuator-component within the door.

FIGS. 10 through 15 show another embodiment (particularly suitable for use with pool gates and the like) in which the actuator-magnet moves in a linear path, and in which:

FIG. 10 is a schematic showing the actuator-magnet in each of the latch-magnet-attracting-position and the latch-magnet-repelling-position;

FIG. 11 is a vertical cross-section perspective view showing the actuator-magnet in the latch-magnet-attracting-position;

FIG. 12 is a vertical cross-section perspective view showing the actuator-magnet in the latch-magnet-repelling-position;

FIG. 13 is a partial cutaway perspective view showing the actuator-magnet in the latch-magnet-attracting-position;

FIG. 14 is a partial cutaway perspective view showing the actuator-magnet in the latch-magnet-repelling-position; and

FIG. 15 is an enlarged view of a portion of FIG. 13.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

International Patent Application PCT/AU2011/000012, also by the present applicants, teaches a magneto-mechanical-latching-assembly and is hereby incorporated by cross-reference.

As used herein, the term “door” is generally used to encompass at least doors and gates, and the term “door jamb” is generally used to encompass at least door-jambs and gate-posts. There are, however, limited instances where the narrower terms are used in the description where the context requires that a distinction be made between doors and gates, or between door-jambs and gate-posts.

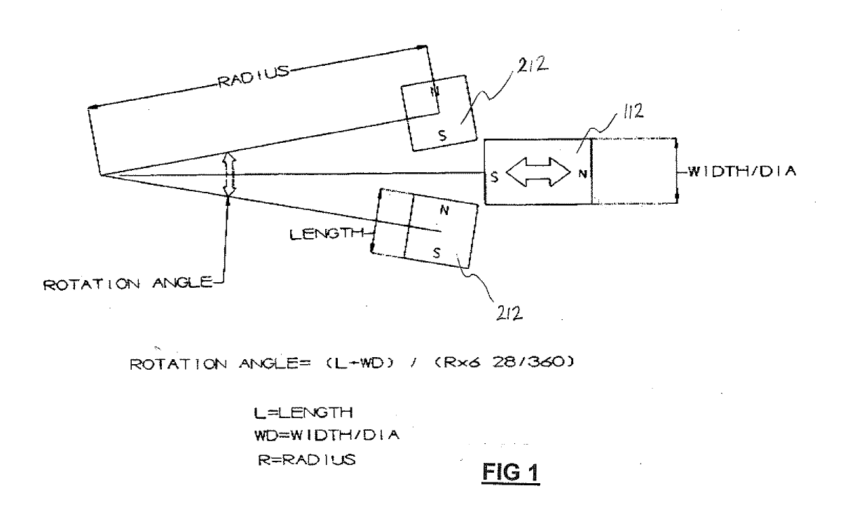

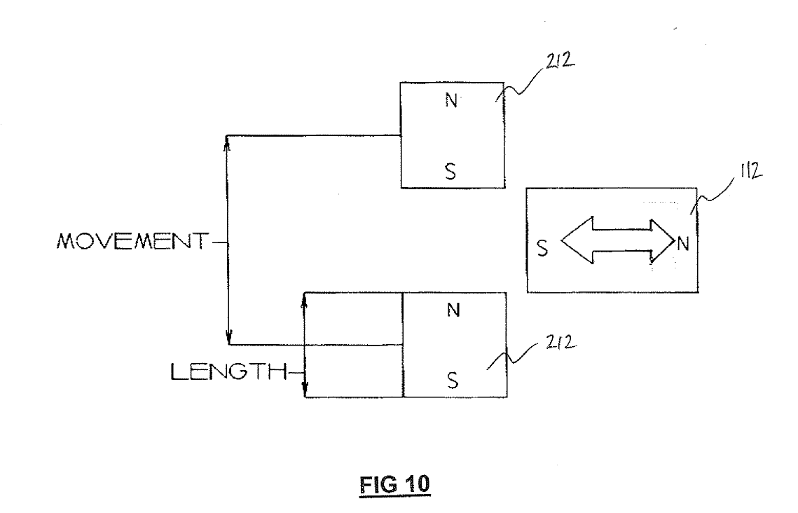

Referring firstly to FIGS. 1 and 10, the common principle of the operation of the two illustrated embodiments will be described.

Two magnets are required for operation, namely a latch-magnet 112 and an actuator-magnet 212.

In both embodiments, the latch-magnet 112 reciprocates on a horizontal and linear latching-path as indicated by the arrows in each of FIG. 1 and FIG. 10.

The latch-magnet 112 is cylindrical in shape, with the axis of the cylinder coincident with the latching-path. The latch-magnet 112 is a rare-earth magnet (neodymium). The latch-magnet 112 has its polar-axis coincident with the latching-path and also coincident with the axis of the cylinder.

The actuator magnet 212 reciprocates on a substantially vertical actuator-path as indicated by the duplication of its representation in each of FIG. 1 and FIG. 10. In FIG. 1, the actuator-path is arcuate (approximately 20 degrees), whereas in FIG. 10 the actuator-path is linear.

The actuator-magnet 212 is cylindrical in shape, with the axis of the cylinder coincident with the actuator-path. The actuator-magnet 212 is a rare-earth magnet (neodymium). The actuator-magnet 212 has its polar axis coincident with the actuator-path and also coincident with the axis of the cylinder.

The actuator-magnet 212 can be moved between the lower illustrated position, at which the cylindrical actuator-magnet 212 and cylindrical latch-magnet 112 are juxtaposed in an edge-to-edge arrangement in which the North (N) pole of the actuator-magnet 212 is adjacent the South (S) pole of the latch-magnet 112 such that the latch-magnet 112 is attracted to the left, and the upper illustrated position, at which the cylindrical actuator-magnet 212 and cylindrical latch-magnet 112 are juxtaposed in another edge-edge arrangement in which the S pole of the actuator-magnet 212 is adjacent the S pole of the latch-magnet 112 such that the latch-magnet 112 is repelled to the right.

Thus, the actuator-magnet 212 moves between an attractive position in which it is substantially below the latch-magnet 112 and a repulsive position in which it is substantially above the latch-magnet 112. In doing so, the actuator-magnet 212 must travel a vertical distance which substantially corresponds to the sum of the vertical dimension of the latch-magnet 112 (i.e. the diameter of the cylindrical latch-magnet) and the vertical dimension of the actuator-magnet 212 (i.e. the length of the cylindrical actuator-magnet).

### LIST OF PARTS (FIRST EMBODIMENT)

Latch-Component 100
Latch 110
Latch-Magnet 112
Housing 120
Flange 130
Flange-Apertures 132
Actuator-Component 200
Actuator 210
Actuator-Magnet 212
Actuator-Arm 214
Housing 220
Latch-Receiving-Recess 230
Flange 240
Flange-Apertures 242
Square-Section-Shaft 250
Door 300
Door-Jamb 400

### DETAILED DESCRIPTION OF THE FIRST EMBODIMENT

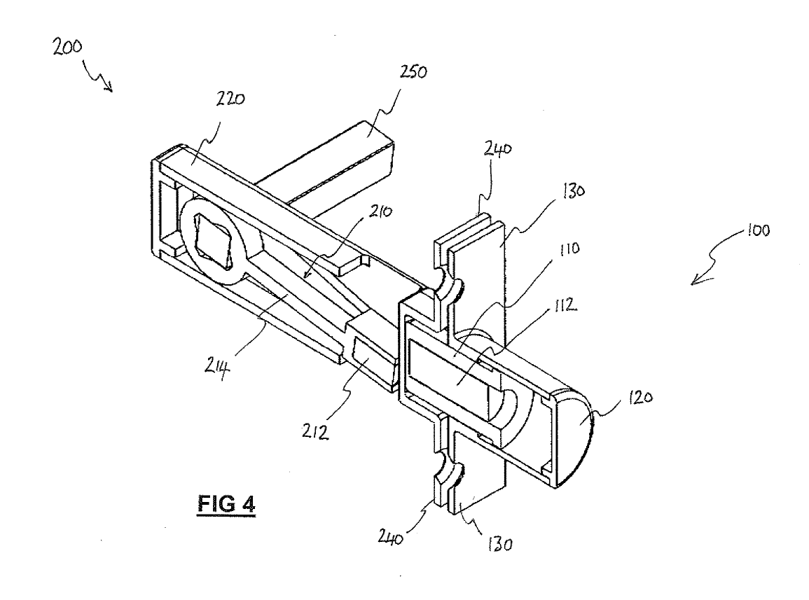

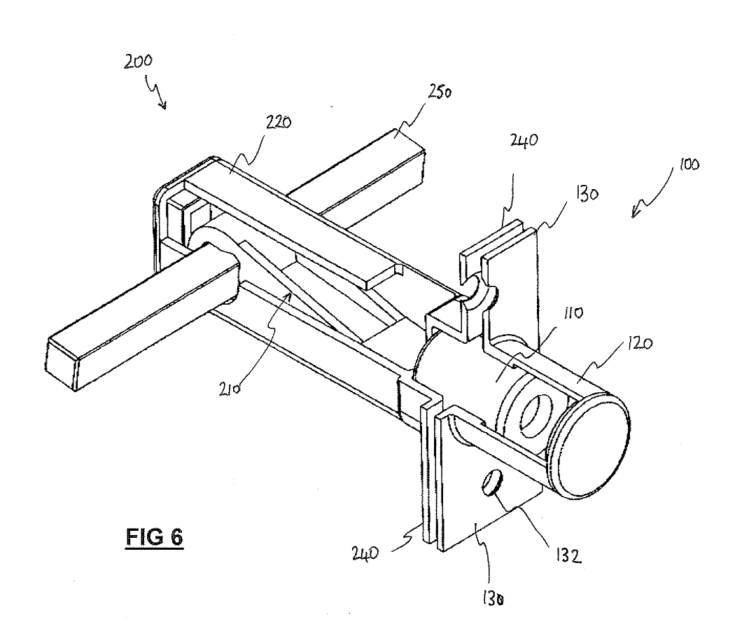

Referring now to FIGS. 1 to 9, there is illustrated a first embodiment which is particularly suitable residential doors and the like.

In this embodiment, the actuator-magnet 212 travels through an arcuate path which lies in a vertical plane.

In this embodiment, the latch-component 100 is mounted relative to the door-jamb 400, and the actuator-component 200 is mounted relative to the door 300.

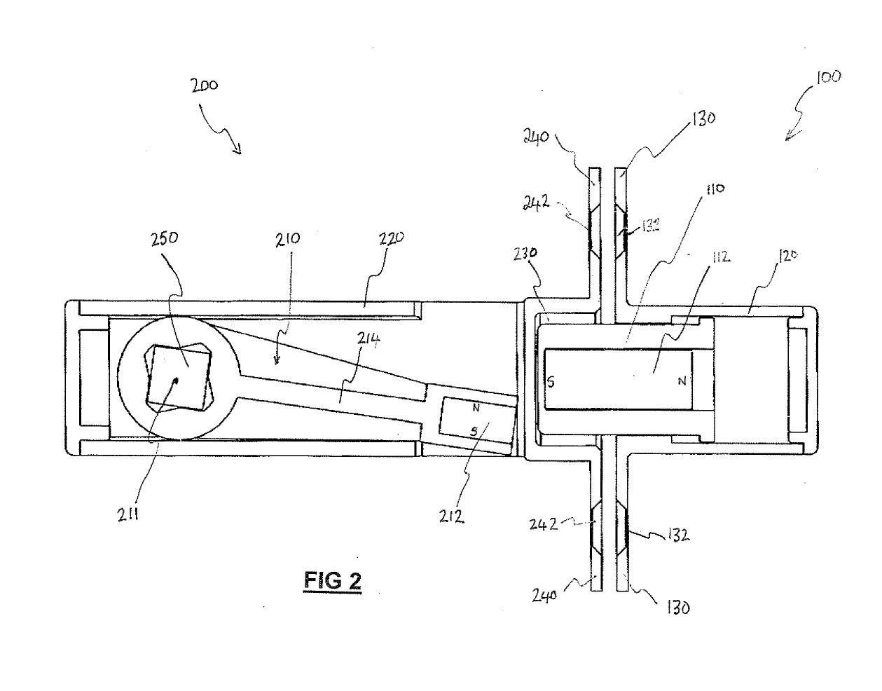

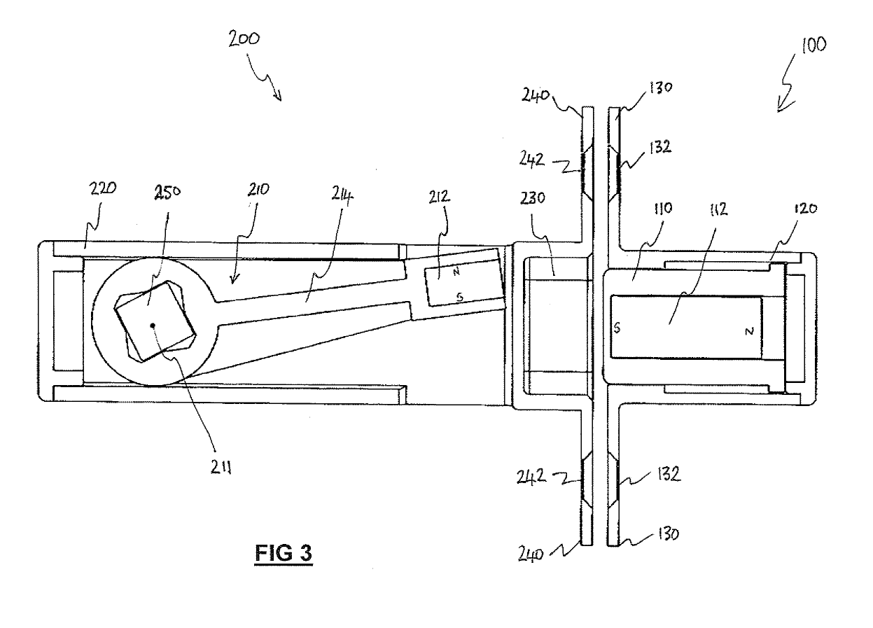

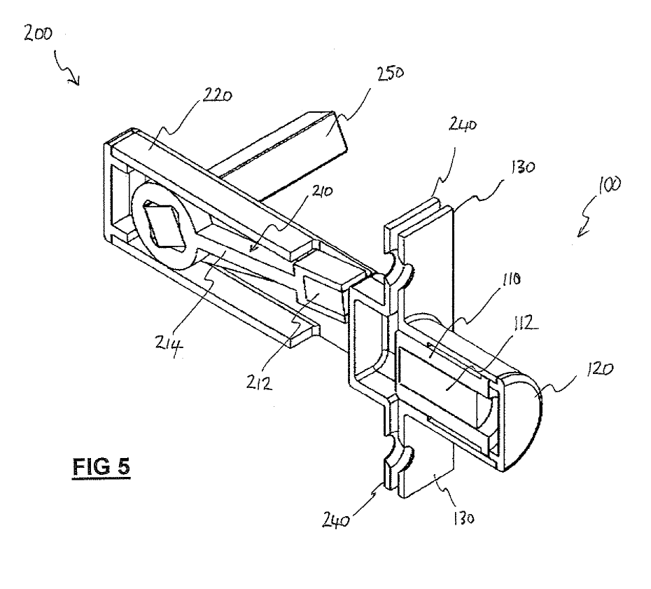

Referring to FIGS. 2 to 6, latch-component 100 comprises a cylindrical latch-magnet 112, as discussed above, which is fixedly mounted within a cylindrical latch 110. Cylindrical latch 110 is mounted for linear, horizontal reciprocation relative to a hollow cylindrical housing 120. Cylindrical latch 110 can reciprocate between an extended-latching-position (shown in FIGS. 2, 4 and 6) and a retracted-non-latching-position (shown in FIGS. 3 and 5).

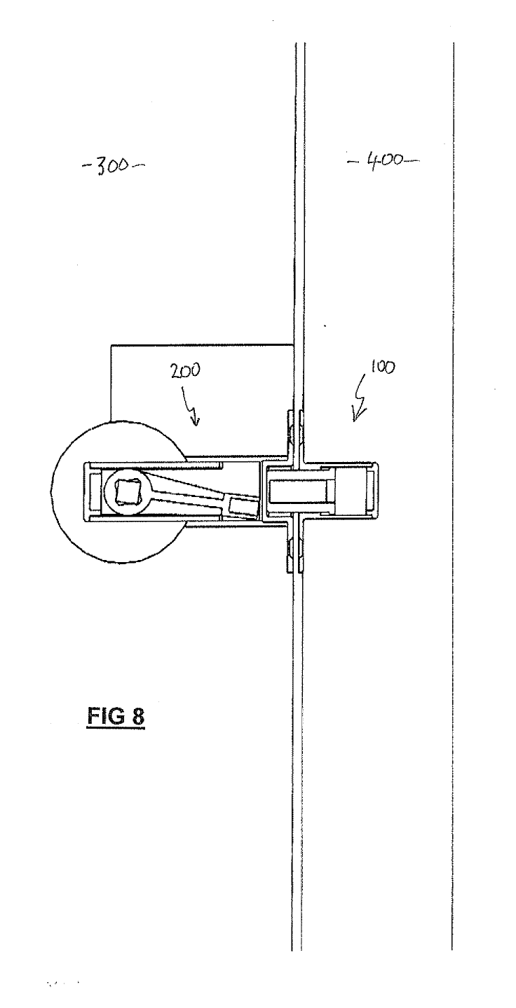

Integral with cylindrical housing 120 is a generally rectangular flange 130 which extends above and below the cylindrical housing 120. The flange 130 includes a pair of flange-apertures 132 which, in use, receive screws which fix the latch-component 100 to the door-jamb 400 (as best shown in FIG. 8).

The parts of the latch-component 100 (other than the latch-magnet 112) may all be fabricated from injection-moulded plastics or other suitable materials.

Still referring to FIGS. 2 to 6, actuator-component 200 comprises a cylindrical actuator-magnet 212 which is fixedly mounted on the distal end of actuator-arm 214. Actuator-arm 214 is mounted within a generally parallelepiped-shaped housing 220 for rotation of ˜20 degrees about its proximal end about an axis indicated at 211. Rotation of actuator-arm 214 through said range of approximately 20 degrees moves actuator-magnet 212 between a lower latch-magnet-attracting-position (FIGS. 2, 4 and 6) and a an upper latch-magnet-repelling-position (FIGS. 3 and 5).

Integral with parallelepiped-shaped housing 220 is a generally rectangular flange 240 which extends above and below the housing 220. The flange 240 includes a pair of flange-apertures 242 which, in use, receive screws which fix the actuator-component 200 to the door 300 (as best shown in FIG. 8).

Also integral with housing 220 is a latch-receiving-recess 230 which is shaped to closely receive latch 110 when latch 110 is in the extended-latching-position. Each of the latch-receiving-recess 230 and latch 110 may have a complementary taper in order to facilitate reception.

The proximal end of the actuator-arm 214 includes a transverse bore which is coincident with axis 211 and which receives square-section-shaft 250 as shown best in FIGS. 2 and 3. A door handle (not shown) is mounted on each end of the square-section-shaft 250 in the conventional manner.

The bore at the proximal end of the actuator-arm 214 is generally shaped like two angularly-offset squares (best seen FIGS. 2 and 3). However, due to additional cut-outs in the profile of the bore, the square-section-shaft 250 can rotate relative to the bore for about 20 degrees (in an anti-clockwise direction in FIGS. 2 and 3) before the square-section-shaft 250 engages the bore and begins to force the actuator-arm 214 to rotate in unison in a counter-clockwise direction with the square-section-shaft 250. This initial “lost-rotation” mechanism ensures that the first ˜20 degrees of anti-clockwise rotation (in FIGS. 2 & 3) of the square-section-shaft 250 does not move the actuator-magnet 212. However, the next ˜20 degrees of anti-clockwise rotation of the square-section-shaft 250 moves the actuator magnet 212 to the upper position at which it repels the latch-magnet 112. Thus, a total handle rotation of approximately 40 degrees is required to unlatch the door. The “lost-rotation” mechanism reduces the reactivity of the system to user input.

The parts of the latch-component 200 (other than the latch-magnet 212) may all be fabricated from injection-moulded plastics or other suitable materials.

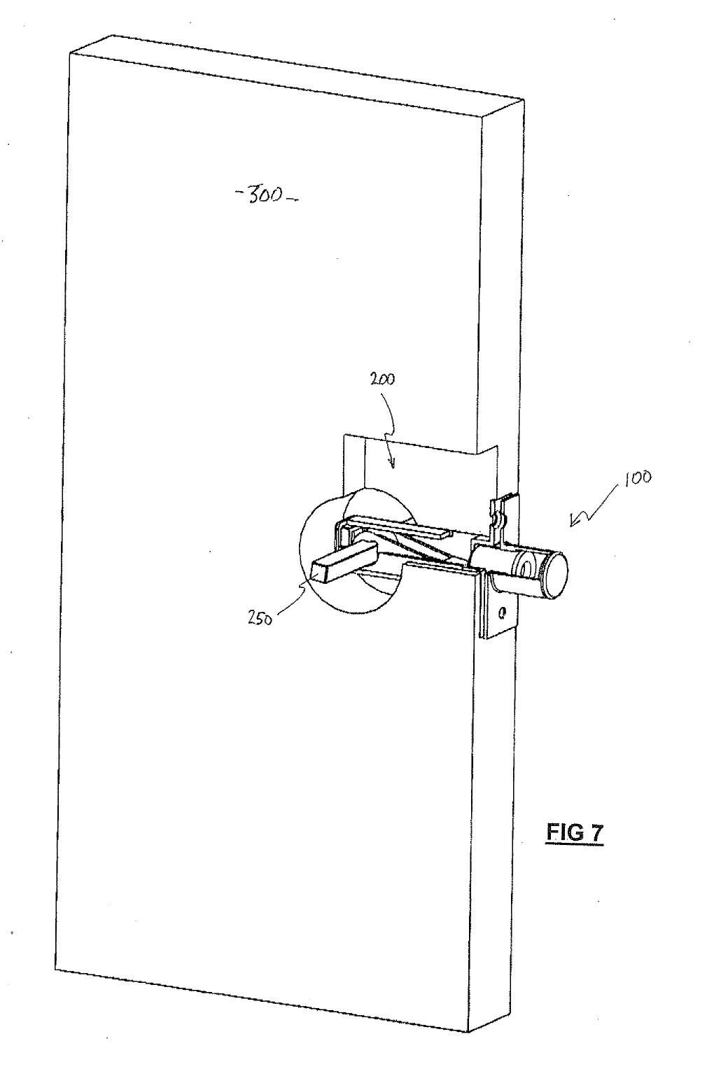

In use (see FIGS. 7 and 8), the latch-component 100 is mounted relative to the door-jamb 400 and the actuator-component 200 is mounted relative to the door 300.

Mounting of the latch-component 100 relative to the door-jamb 400 involves creating a cylindrical cavity in the door-jamb 400 (e.g. via drilling), and creating a small rebate in the door-jamb for receiving the flange 130 (e.g. via chiseling).

The cylindrical housing 120 is then inserted into the cylindrical cavity in the door-jamb. Screws (not shown in FIG. 8) are then passed through the flange-apertures 132 to engage the door-jamb 400 to fix the latch-component 100 in place.

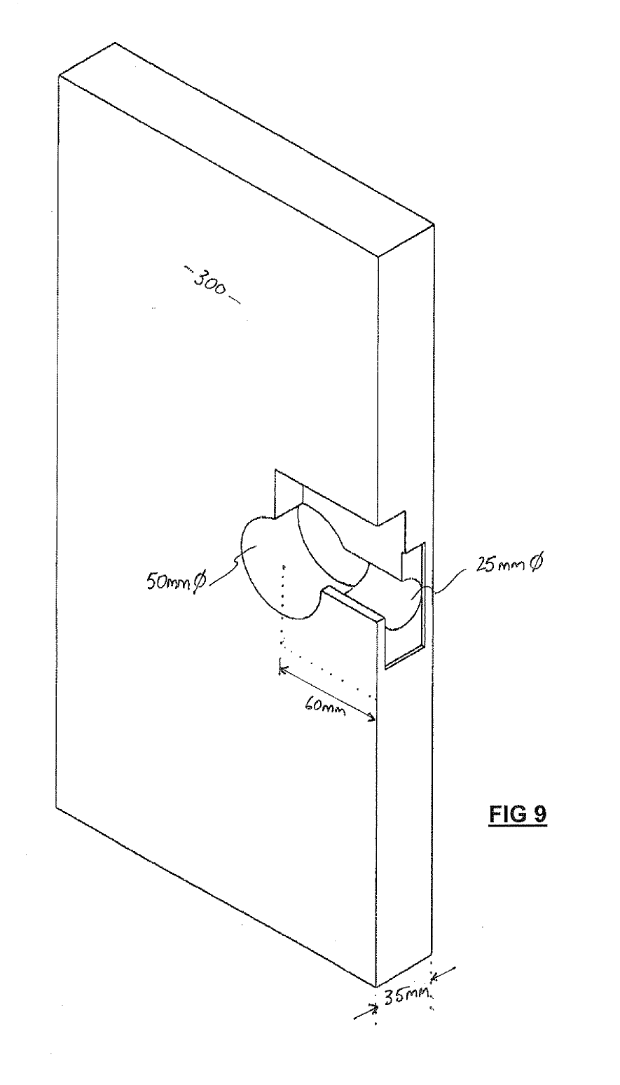

Similarly, mounting the actuator-component 200 relative to the door involves creating a cylindrical shaped cavity in the edge of the door 300 (this cylindrical cavity in the edge of the door 300 is typically 25 mm is diameter—note that the thickness of a conventional residential door 300 is 35 mm), and creating a small rebate in the edge of the door 300 for receiving the flange 240 (refer to FIG. 9). Additionally, a transverse cylindrical hole is formed through the door 300. This transverse hole is typically centered 60 mm from the edge of the door 300 and the hole is typically 50 mm in diameter (refer to FIG. 9). Note that many doors are supplied with these cylindrical cavities pre-formed.

The parallelepiped-shaped actuator-component 200 is then inserted through the edge of the door 300 via the 25 mm cylindrical hole and it is fixed in place with screws which pass through flange-apertures 242 to engage the edge of the door 300.

Thereafter, the square-section-shaft 250 is introduced transversely relative to the plane of the door 300 and the square-section-shaft 250 is threaded through the bore in the proximal end of the actuator-arm 214. Finally, cosmetic covers are fitted, and conventional handles (not shown) are mounted on each end of the square-section-shaft 250.

Whilst gravity will tend to ensure that the actuator-arm 214 (and actuator-magnet 212) naturally reside in the lower, latch-attracting position (FIGS. 2, 4 and 6) it is preferred that a spring or other resilient member be additionally provided to bias the actuator-arm 214 towards the lower latch-attracting orientation.

In summary, when the door is unlatched via manipulation of the handle (not shown), the actuator-magnet 212 is raised to the upper position and the latch 110 is repelled to the position (FIGS. 3 and 5) where it is retracted and substantially flush with flange 130. When the user manipulation of the handle is discontinued, the actuator-magnet 212 returns to the default lower position. Hence, when the door returns to the closed position, the latch 110 is automatically engaged with the latch-receiving-recess 230 (FIGS. 2, 4, and 6) by virtue of the attraction between the respective magnets.

### LIST OF PARTS (SECOND EMBODIMENT)

Where possible, the same references numerals have been used in the second embodiment as in the first embodiment.
Latch-Component 100
Latch 110
Latch-Magnet 112
Housing 120
Actuator-Component 200
Actuator 210
Actuator-Magnet 212
Actuator-Magnet-Carriage 213
Actuator-Rod 216
Flange 217
Lift-Knob 218
Housing 220
Latch-Receiving-Recess 230
Spring 260

### DETAILED DESCRIPTION OF SECOND EMBODIMENT

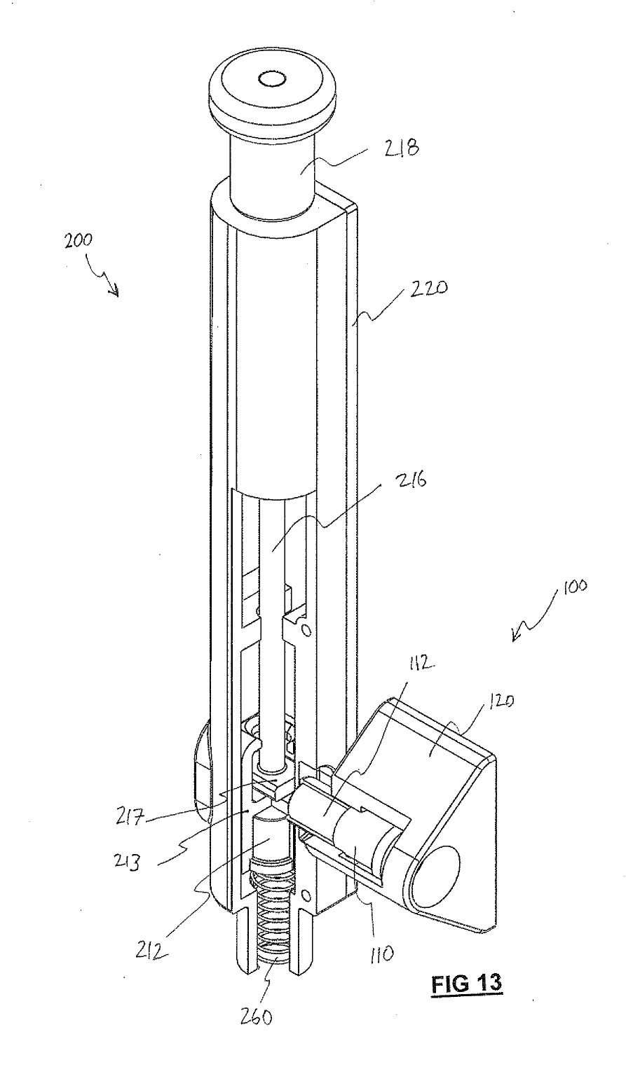

Referring now to FIGS. 10 to 15, there is illustrated a second embodiment which is particularly suitable for pools gates and the like.

In this embodiment, the actuator-magnet travels through a linear path.

In this embodiment, the latch-component is preferably mounted to the gate, and the actuator-component is preferably mounted to the gate post. However, this can be reversed, if desired.

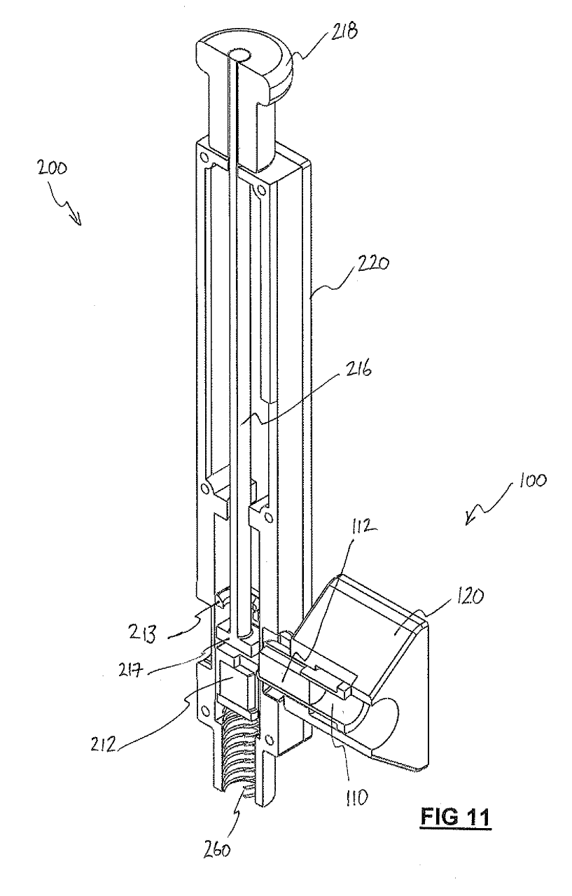

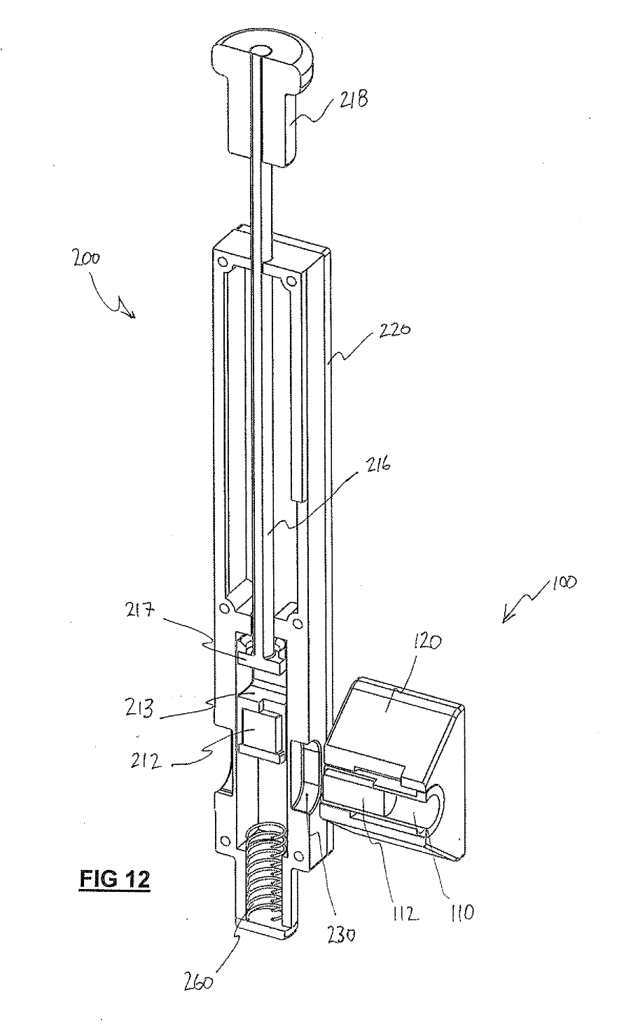

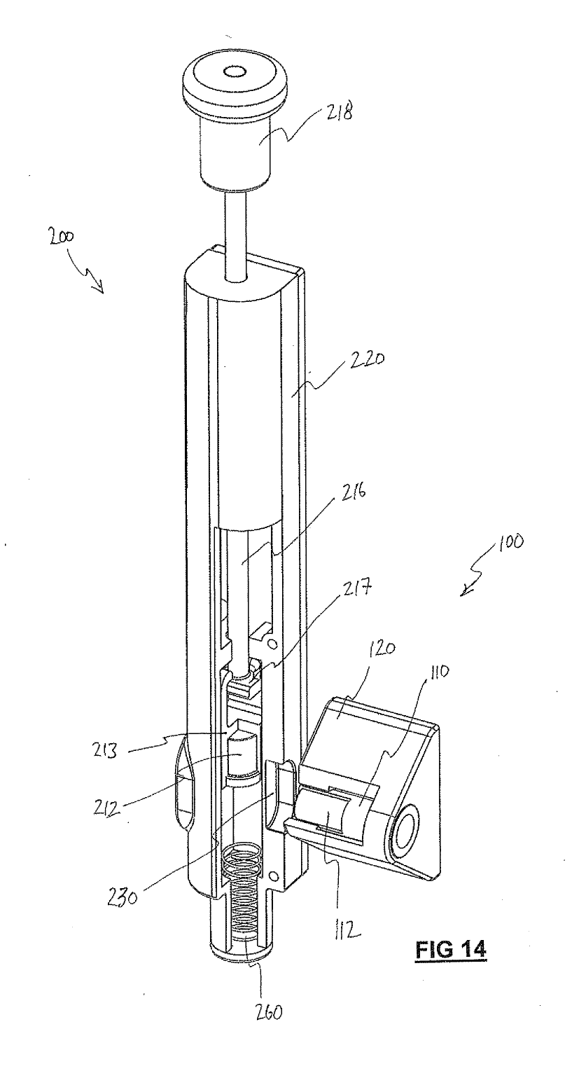

Latch-component 100 is very similar to the latch-component of the first embodiment. In particular, there is a cylindrical latch-magnet 112 fixedly mounted within a cylindrical latch 110. As previously, the latch 110 reciprocates on a linear and horizontal latching-path between an extended-latching-position (FIGS. 11, 13, and 15) and a retracted-non-latching-position (FIGS. 12 and 14) at which it is flush.

The main difference between the latch-component 100 of the second embodiment and the latch-component of the first embodiment resides in the different shape of housing 120. In the second embodiment, the housing 120 is exposed when the latch-component 100 is mounted on the gate and therefore it is shaped to prevent children from easily climbing on the gate and using the housing 120 as a foothold. The housing 120 is adapted to be mounted to a pool gate via screws and apertures (not shown).

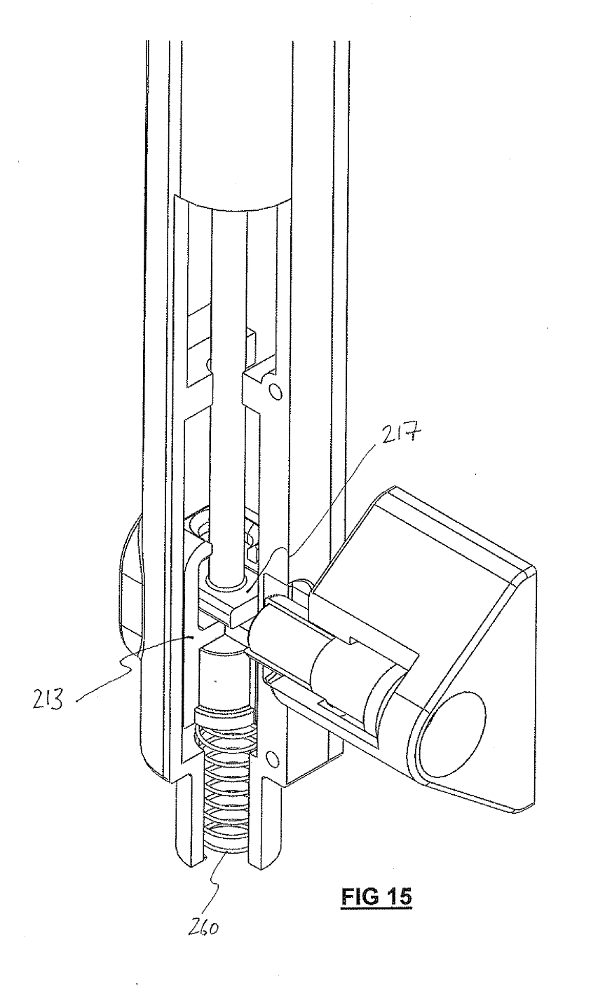

As previously, the parts of the latch-component 100 (other than the latch-magnet 112) may be formed from injection moulded plastics or other suitable materials. Actuator-component 200, or more particularly housing 220, is adapted to be mounted to a gate post. Actuator-component 200 comprises an actuator-magnet 212. Actuator-magnet 212 is mounted in an actuator-magnet-carriage 213 which is perhaps been illustrated in the cutaway view in FIG. 15. Actuator-magnet-carriage 213 has a lower chamber, which accommodates the actuator-magnet 212, and an upper chamber which loosely accommodates a flange 217 provided on the lower end of actuator-rod 216. The upper end of actuator-rod 216 is connected to a lift-knob 218.

Still referring to FIG. 15, as can be seen, the actuator-rod 216 and the actuator-magnet-carriage 213 are not fixedly mounted relative to each other. Rather, the flange 217 of the lower end of the actuator-rod 216 is loosely received in the upper chamber of the actuator-magnet-carriage 213. Consequently, the actuator-magnet-carriage 213 can move through a limited range of vertical travel relative to the flange 217 without causing a consequential vertical movement of the actuator-rod 216. As shown in FIG. 15, the actuator-magnet-carriage 213 can move slightly downwards or slightly upwards relative to the flange 217. The vertical travel of the actuator-magnet-carriage 213 relative to the actuator rod 216 is limited by the abutment of the flange 217 with the ceiling and floor of the upper chamber of the actuator-magnet-carriage 213.

Located below the actuator-magnet-carriage 213, and within the housing 220, is a spring 260 which tends to resist downward travel of the actuator-magnet-carriage 213. The purpose of the “loose” mounting of the actuator-magnet-carriage 213 relative to the actuator rod 216, and the purpose of the spring 260, relates to the issue of gate “sag” and will be discussed in more detail shortly.

In use, the latch-component 100 is mounted to the pool gate (not shown) and the actuator-component 200 is mounted to the gate post (not shown). The lift-knob 218, which is located in an elevated position in order to be out of the reach of children, can be lifted to thereby lift the actuator-rod 216, the actuator-magnet-carriage 213 and the actuator-magnet 212. This causes the latch-magnet 112 to be repelled and the latch 110 to be repelled to the retracted, flush position (FIGS. 12 and 14).

Upon release of the lift-knob 218, actuator-rod 216, actuator-magnet-carriage 213 and actuator-magnet 212 all return to the lower, latch-attracting position (FIGS. 11, 13 and 15) under the effect of gravity. Optionally, a return spring may be added to further bias this return movement of the actuator-rod 216.

In the pool gate environment, there is the possibility that the gate will sag relative to the gate post, particularly with wear and age. This potential sag problem is amplified by the fact that children tend to climb on the gate and this additional weight on the gate tends to urge the gate further downward towards the ground. It is important that this possible downward subsidence of the gate relative to the gate post does not impact on the functioning of the magneto-mechanical-latching-assembly.

The “loose” mounting of the actuator-magnet-carriage 213 relative to the actuator-rod 216, and the presence of the spring 260, guard against this “sag” scenario. In particular, and with reference to FIG. 15, if the latch-component 100 were moved slightly downwardly relative to the actuator-component 200, then the actuator-magnet 212 and the actuator-magnet-carriage 213 are able to move downwardly and spring 260 is slightly compressed. Conversely, if the latch-component 100 were slightly lifted, then the actuator-magnet 212 and actuator-magnet-carriage 213 are able to rise and the spring 260 de-compresses.

One benefit of the present embodiment, at least when compared to the embodiment disclosed in the earlier International Patent Application PCT/AU2011/000012 which is cross-referenced above, is the fact that no modification of the actuator component (specifically, reversal of the actuator magnet(s) as discussed in the referenced application) is required in order to accommodate both left-hand opening and right-hand opening gates. Thus, it is impossible to make an error during installation.

Throughout this specification and the claims, unless the context requires otherwise, the word “comprise” and its variations, such as “comprises” and “comprising,” will be understood to imply the inclusion of a stated integer or step or group of integers or steps but not the exclusion of any other integer or step or group of integers or steps.

The reference to any prior art in this specification is not, and should not be taken as, an acknowledgement or any form of suggestion that such art forms part of the common general knowledge in Australia, nor that it would have been ascertained, understood and regarded as relevant by the skilled person.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. In combination with a door and a door-jamb, wherein the door is mounted to close an opening adjacent to the door-jamb, a magneto-mechanical-latching-assembly which operates to secure the door in a closed position, the magneto-mechanical-latching-assembly comprising:
a latch-component associated with one of the door and door-jamb, the latch-component comprising a latch, the latch comprising a latch-magnet having a latch-magnet-polar-axis, the latch being mounted relative to the latch-component to reciprocate along a substantially horizontal and linear latching-path between an extended-latching-position and a retracted-non-latching-position;
an actuator-component associated with the other of the door and door-jamb, the actuator-component comprising an actuator, the actuator comprising an actuator-magnet having an actuator-magnet-polar-axis, the actuator-magnet being mounted relative to the actuator-component to reciprocate along a substantially vertical actuator-path between a latch-magnet-attracting-position and a latch-magnet-repelling-position.

2. A combination as claimed in claim 1, wherein, when the latch is in the retracted-non-latching-position, the latch is substantially flush with the door or door-jamb.

3. A combination as claimed in claim 1, wherein the latch-magnet-polar-axis is substantially horizontal and substantially parallel to the latching-path, and the actuator-magnet-polar-axis is substantially vertical and substantially parallel to the actuator-path.

4. A combination as claimed in claim 1, wherein the latch-component is associated with the door-jamb and the actuator-component is associated with the door.

5. A combination as claimed in claim 4, wherein the substantially horizontal and linear latching-path is substantially parallel to the plane of the opening.

6. A combination as claimed in claim 5, wherein the substantially horizontal and linear latching path lies in the plane of the opening such that the latch projects into the plane of the opening when the latch is in the extended-latching-position.

7. A combination as claimed in claim 4, wherein the actuator-path is arcuate.

8. A combination as claimed in claim 7, wherein the actuator comprises a handle, and the handle is mounted for limited rotational travel relative to the actuator.

9. A combination as claimed in claim 1, wherein the latch-component is associated with the door and the actuator-component is associated with the door-jamb.

10. A combination as claimed in claim 9, wherein the actuator-path is linear.

11. A combination as claimed in claim 9, wherein the substantially horizontal and linear latching-path is substantially parallel to the plane of the door.

12. A combination as claimed in claim 9, wherein the actuator-magnet is mounted for limited vertical travel relative to the actuator in order to accommodate vertical misalignment of the door relative to the door-jamb.

13. A combination as claimed in claim 12, wherein biasing means bias the actuator-magnet towards one end of said limited vertical travel.

14. A combination as claimed in claim 1, wherein the latch-magnet has a vertical dimension (A) in a direction substantially transverse to the latching-path, and wherein the actuator-magnet has a vertical dimension (B) in a direction substantially parallel to the actuator-path, and wherein the actuator-magnet travels a vertical distance of approximately A+B along the actuator-path between the latch-magnet-attracting-position and the latch-magnet-repelling-position.

15. A combination as claimed in claim 1, wherein the latch-magnet is cylindrical with the axis of the cylinder substantially aligned with the latch-magnet-pole-axis and latching-path, and wherein the actuator-magnet is cylindrical with the axis of the cylinder substantially aligned with the actuator-magnet-pole-axis and actuator-path, and wherein the cylindrical-latch-magnet and cylindrical-actuator-magnet are substantially in opposed edge-to-edge juxtapositions when in each of the latch-magnet-attracting-position and the latch-magnet-repelling-position.

16. A combination as claimed in claim 1, wherein, when the actuator-magnet is in the latch-magnet-attracting-position, the actuator-magnet is substantially located vertically to one side of the latching-magnet and, when the actuator-magnet is in the latch-magnet-repelling-position, the actuator-magnet is substantially located vertically to the other side of the latching-magnet.

17. A magneto-mechanical-latching-assembly suitable for use in combination with a door and a door-jamb as defined in claim 1.

18. A magneto-mechanical-latching-assembly comprising:
a latch-component adapted to be associated with one of a door and door-jamb, the latch-component comprising a latch, the latch comprising a latch-magnet having a latch-magnet-polar-axis, the latch being mounted relative to the latch-component to reciprocate along a linear latching-path between an extended-latching-position and a retracted-non-latching-position;
an actuator-component adapted to be associated with the other of the door and door-jamb, the actuator-component comprising an actuator, the actuator comprising an actuator-magnet having an actuator-magnet-polar-axis, the actuator-magnet being mounted relative to the actuator-component to reciprocate along an actuator-path between a latch-magnet-attracting-position and a latch-magnet-repelling-position.

19. A magneto-mechanical-latching-assembly as claimed in claim 18, wherein, when the latch is in the retracted-non-latching-position, the latch is retracted to a substantially flush position.

20. A magneto-mechanical-latching-assembly as claimed in claim 18, wherein, the actuator comprises a handle and the handle is mounted for limited rotational travel relative to the actuator.

21. A magneto-mechanical-latching-assembly as claimed in claim 18, wherein, the actuator-magnet is mounted for limited vertical travel relative to the actuator.

22. A magneto-mechanical-latching-assembly as claimed in claim 21, wherein biasing means bias the actuator-magnet towards one end of said limited vertical travel.
